(19) United States
(12) Patent Application Publication
(10) Pub. No.: US 2026/0238585 A1
(43) Pub. Date: Aug. 13, 2026

(54) NETWORK DEVICE AND ROUTING METHOD WITH EQUAL-COST MULTI-PATH ROUTING DYNAMIC ADJUSTMENT MECHANISM

(71) Applicant: REALTEK SINGAPORE PRIVATE LIMITED, SINGAPORE (SG)

(72) Inventor: Donggun Keung, Milpitas, CA (US)

(21) Appl. No.: 19/050,159

(22) Filed: Feb. 11, 2025

(51) Int. Cl. H04L 45/121; H04L 45/00; H04L 45/02

(52) U.S. Cl. CPC H04L 45/121; H04L 45/02; H04L 45/566

(57) ABSTRACT

A network device and a routing method with an equal-cost multi-path (ECMP) routing dynamic adjustment mechanism are provided. The routing method includes: obtaining an ingress packet of an ingress traffic through a network interface circuit of a network device; and configuring a processor of the network device to execute following processes: extracting packet information from the ingress packet, and calculating and obtaining a forwarding decision parameter by using a traffic forwarding decision function; continuously obtaining a plurality of current queue states of a plurality of ECMP member egress ports of an ECMP group; and selecting one of the ECMP member egress ports from the ECMP group based on the forwarding decision parameter and the plurality of current queue states to forward the ingress traffic.

### FIELD OF THE DISCLOSURE

The present disclosure relates to a network device and method, and more particularly to a network device and a routing method with an equal-cost multi-path (ECMP) routing dynamic adjustment mechanism.

### BACKGROUND OF THE DISCLOSURE

In existing network devices, such as residential gateways (RGs), network traffic is forwarded by using the longest prefix matching technique based on the IP destination address.

Equal-cost multi-path (ECMP) routing is a routing strategy that allows packets to be forwarded across multiple optimal paths with the same routing priority. When adopting an ECMP routing architecture, to ensure that packets are transmitted in order, each traffic flow must pass through the same intermediate nodes between the source host and the destination host, which ensures that identical traffic flows use the same egress port.

However, in practical applications, the current ECMP routing mechanism is unable to dynamically adjust traffic based on the real-time conditions of each egress port. For example, if network congestion occurs on the selected egress port's data path, the ECMP port does not perform any adjustments, resulting in increased traffic delays and a higher packet loss rate.

Therefore, improving the ECMP mechanism has become one of important issues to be addressed in the art.

### SUMMARY OF THE DISCLOSURE

In response to the above-referenced technical inadequacies, the present disclosure provides a network device and a routing method with an equal-cost multi-path (ECMP) routing dynamic adjustment mechanism.

In order to solve the above-mentioned problems, one of the technical aspects adopted by the present disclosure is to provide a routing method with an equal-cost multi-path (ECMP) routing dynamic adjustment mechanism, and the routing method includes: obtaining an ingress packet of an ingress traffic through a network interface circuit of a network device; and configuring a processor of the network device to execute following processes: extracting packet information from the ingress packet, and calculating and obtaining a forwarding decision parameter by using a traffic forwarding decision function; continuously obtaining a plurality of current queue states of a plurality of ECMP member egress ports of an ECMP group; and selecting one of the ECMP member egress ports from the ECMP group based on the forwarding decision parameter and the plurality of current queue states to forward the ingress traffic.

In order to solve the above-mentioned problems, one of the technical aspects adopted by the present disclosure is to provide a network device with the ECMP dynamic adjustment mechanism, and the network device includes a network interface circuit, a memory and a processor. The network interface circuit is configured to obtain an ingress packet of an ingress traffic. The processor is electrically connected to the network interface circuit and the memory, and the processor is configured to execute: extracting packet information from the ingress packet, and calculating and obtaining a forwarding decision parameter by using a traffic forwarding decision function; continuously obtaining a plurality of current queue states of a plurality of ECMP member egress ports of an ECMP group; and selecting one of the ECMP member egress ports from the ECMP group based on the forwarding decision parameter and the plurality of current queue states to forward the ingress traffic.

Therefore, in the network device and the routing method with the ECMP routing dynamic adjustment mechanism provided by the present disclosure, traffic can be dynamically adjusted and distributed based on the current traffic condition of each member egress port within the ECMP group, such as the queue length and the queue delay. Additionally, new traffic can be directed to the ECMP member egress port with the least congestion, which helps alleviate traffic congestion and minimizes traffic delay to the greatest extent.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a network device with an ECMP routing dynamic adjustment mechanism according to the present disclosure;

FIG. 2 is a flowchart illustrating a routing method with an ECMP routing dynamic adjustment mechanism according to one embodiment of the present disclosure;

FIG. 3 is another flowchart illustrating the routing method with an ECMP routing dynamic adjustment mechanism according to one embodiment of the present disclosure;

FIG. 4 is a block diagram illustrating a data path configuration according to one embodiment of the present disclosure;

FIG. 5 is a detailed flowchart of step S23; and

FIG. 6 is a schematic diagram illustrating a queue management circuit updating a queue state table according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure introduces an innovative adjustment and selection scheme for ECMP egress ports, aiming to dynamically distribute traffic across available ECMP egress ports based on the current congestion status and latency status. This approach ensures that each ECMP member egress port is fully utilized, thereby minimizing traffic congestion, latency and reducing the likelihood of packet loss to the greatest extent possible.

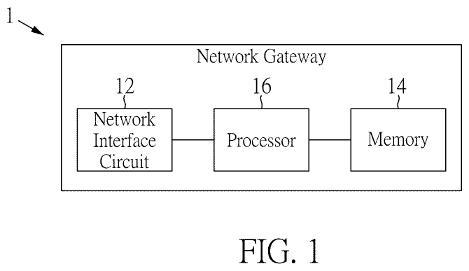

Referring to FIG. 1, FIG. 1 is a functional block diagram of a network device with an ECMP routing dynamic adjustment mechanism according to the present disclosure. In this embodiment, the network device may be, for example, a network gateway 1, which includes a network interface circuit 12, a memory 14, and a processor 16, and the processor 16 is electrically connected to the network interface circuit 12 and the memory 14.

The network interface circuit 12 has multiple network ports, which can be used, for example, to connect to a local area network (LAN) and a wide area network (WAN), enabling the network gateway 1 to exchange network messages with other network nodes through relevant standard protocols.

The memory 14 can be any type of memory, a similar storage element, or a combination of the aforementioned elements. In this embodiment, the memory 14 not only stores a program for implementing the routing method with the ECMP routing dynamic adjustment mechanism of this embodiment, but also stores various information related to the network traffic received by the network gateway 1, such as a source Internet Protocol (IP) address, a destination IP address, a source port, a destination port and service chain, and information including nodes' names and sequences from the source to the destination. Additionally, the memory 14 stores essential data structures used during the execution of the routing method, including a routing table, a switching forwarding database, a traffic forwarding table, and a queue state table.

The processor 16 can be a central processing unit (CPU), a microprocessor, an application-specific integrated circuit (ASIC), a programmable logic device (PLD), or another similar circuit device. In this embodiment, the processor 16 is responsible for the overall operation of the network gateway 1 and is capable of accessing and executing programs stored in the memory 14 to implement the routing method with an ECMP routing dynamic adjustment mechanism of this embodiment.

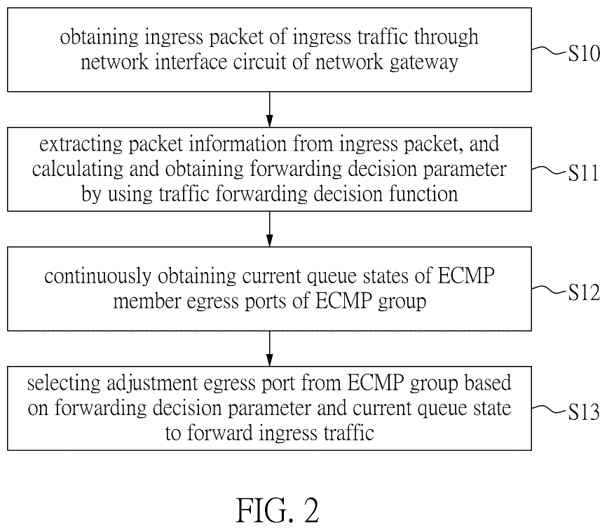

FIG. 2 is a flowchart illustrating a routing method with an ECMP routing dynamic adjustment mechanism according to one embodiment of the present disclosure. Referring to FIGS. 1 and 2, the method of the present embodiment is applicable to the aforementioned network gateway 1. The following describes the detailed process of the routing method of this embodiment in conjunction with the components of the network gateway 1 shown in FIG. 1.

As shown in FIG. 2, the routing method with the ECMP routing dynamic adjustment mechanism includes the following steps:
Step S10: obtaining an ingress packet of an ingress traffic through the network interface circuit 12 of the network gateway 1.

Next, the processor 16 of the network gateway 1 is configured to execute the following steps:
Step S11: extracting packet information from the ingress packet, and calculating and obtaining a forwarding decision parameter by using a traffic forwarding decision function. In the configuration of the ECMP architecture, the forwarding decision parameter can be computed using a traffic forwarding decision function, such as a hash function, where the forwarding decision parameter can be, for example, a hash value. Moreover, an IP source address, an IP destination address, a Layer 4 (L4) source port, an L4 destination port, and an IP protocol ID of the ingress packet can be used as input parameters for the hash function. For the IPv6 protocol, flow_label value in the IPv6 packet header can also be used as one of the input parameters.
Step S12: continuously obtaining a plurality of current queue states of a plurality of ECMP member egress ports of an ECMP group. The ECMP group refers to a set of multiple paths of equal cost with the goal to achieve traffic load sharing. These paths have identical cost-based metrics in the routing table and are therefore considered equivalent optimal paths. The paths within the ECMP group correspond to multiple ECMP egress ports, and are used to distribute traffic among multiple equivalent paths. By utilizing the ECMP egress ports, higher bandwidth utilization and improved network performance can be achieved.

In one embodiment of the present disclosure, the network gateway 1 is provided with a function for monitoring a queue length and a queue delay. The function allows the network gateway 1 periodically checks a current queue state of each ECMP egress port, including a current queue length and a current queue delay.
Step S13: selecting an adjustment egress port from the ECMP group based on the forwarding decision parameter and the current queue state to forward the ingress traffic. For example, after obtaining the current queue state of each ECMP egress port, the current queue length and the current queue delay of each ECMP egress port can be used for comparison. Ultimately, the ECMP egress port with the lowest congestion level can be selected to forward the traffic. The lowest congestion level can refer to, for example, the shortest current queue length and the shortest current queue delay, but the present disclosure is not limited thereto.

It should be noted that FIG. 2 primarily provides a general overview of the routing method with the ECMP routing dynamic adjustment mechanism of the present disclosure, and the following sections will further elaborate on details of the routing method.

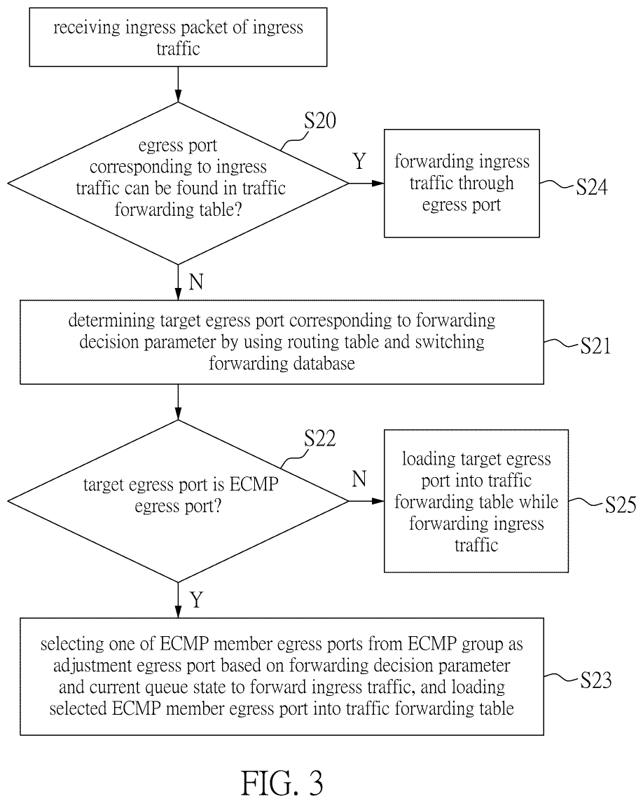

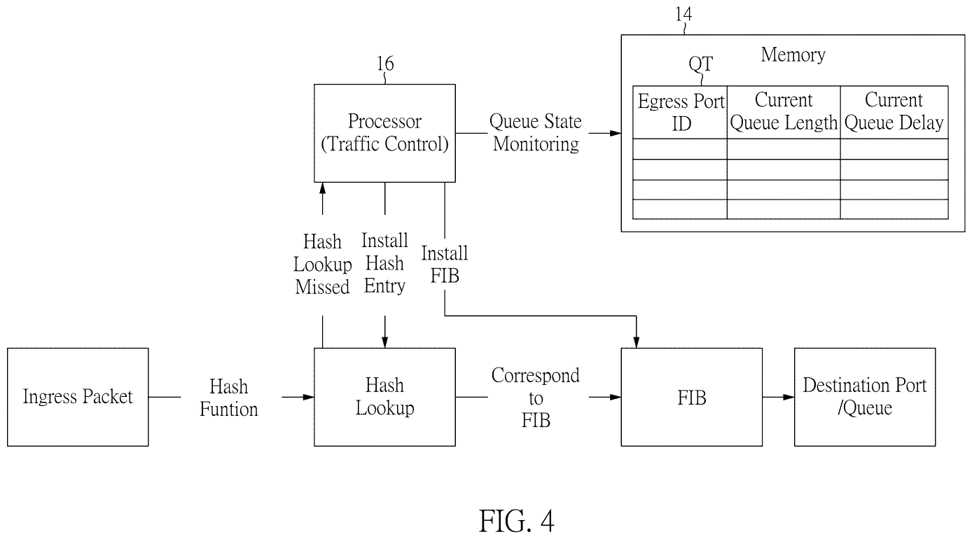

Referring to FIGS. 3 and 4, FIG. 3 is another flowchart illustrating the routing method with an ECMP routing dynamic adjustment mechanism according to one embodiment of the present disclosure, and FIG. 4 is a block diagram illustrating a data path configuration according to one embodiment of the present disclosure.

Referring to FIG. 3, upon receiving an ingress packet of the ingress traffic, Step S20 is executed: determining whether an egress port corresponding to the ingress traffic can be found in a traffic forwarding table. Specifically, in an initial stage of the network gateway 1, when the network gateway 1 receives a data packet of the ingress traffic, the network gateway 1 is configured to compute a hash value of a destination IP address, a source IP port ID, a destination IP port ID and an IP protocol ID, using a hash function, and then search for a corresponding routing entry in a hash table. The network gateway 1 then selects the route with the longest matching prefix. If the hash lookup fails, it indicates that the data packet belongs to a new ingress traffic, and other processing steps can be performed.

In response to failing to find the egress port corresponding to the ingress traffic in the traffic forwarding table, the routing method proceeds to step S21: determining a target egress port corresponding to the forwarding decision parameter by using a routing table and a switching forwarding database. At this step, after computing the hash value of the ingress packet as described in step S11, an L3 routing table, an L2 forwarding database, and/or custom classification operations can be used to determine the corresponding forwarding information base (FIB) entry. The FIB entry can include, for example, a destination address, a next-hop information, an output port (i.e., the target egress port), and routing metrics (e.g., a hop count, a delay, and a bandwidth).

Next, step S22 is executed: determining whether the target egress port is an ECMP egress port. For example, this determination can be made by checking whether the target egress port is one of the ECMP member egress ports within the ECMP group.

In response to determining in step S22 that the target egress port is the ECMP egress port, the routing method proceeds to step S23: selecting one of the ECMP member egress ports from the ECMP group as the adjustment egress port based on the forwarding decision parameter and the current queue state to forward the ingress traffic, and loading the selected ECMP member egress port into the traffic forwarding table. For example, a traffic forwarding hash value corresponding to the ingress traffic and an FIB entry of the selected adjustment egress port can be created in the traffic forwarding table.

Specifically, if the target egress port is the ECMP egress port, the current queue lengths and the current queue delays of all ECMP member egress ports will be used as input parameters for selecting the target egress port. As previously mentioned, if the selection criterion is based on the shortest current queue length and current queue delay, the new ingress traffic can be ensured to be forwarded through the ECMP member egress port with the shortest queue length and the shortest queue delay, thereby optimizing load balancing and minimizing congestion.

It should be noted that memory 14 can be used to store a queue state table QT, which defines a port identifier (ID) of each ECMP member egress port and a queue state corresponding thereto, including a current queue length and a current queue delay.

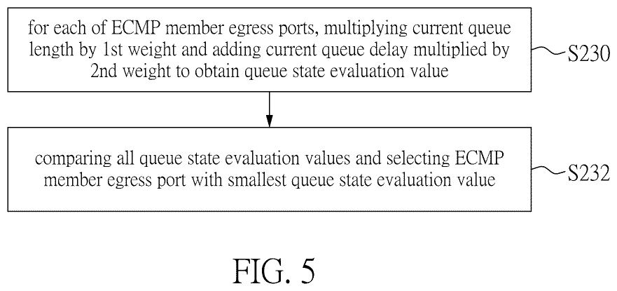

FIG. 5 is a detailed flowchart of step S23. Referring to FIG. 5, in some embodiments, step S23 can include the following steps:
Step S230: for each of the ECMP member egress ports, multiplying the current queue length by a first weight and adding the current queue delay multiplied by a second weight to obtain a queue state evaluation value.
Step S232: comparing all the queue state evaluation values and selecting the ECMP member egress port with the smallest queue state evaluation value.

For example, in the above steps, the queue state evaluation value can be represented by the following equation:

$$Queue state evaluation value = α * current queue length + β * current queue delay .$$

Where α is the first weight, and β is the second weight. The values of α and β can be set within a predetermined range, for example, between 0.1 and 10, and can be configured by a user or a system administrator. The first weight and the second weight can be configured globally, per port, per queue, or based on classifier rules.

For example, when considering a consumption level of a packet buffer, in order to prevent a single queue from excessively consuming the available packet buffer, the user can set the first weight to a relatively higher value within the predetermined range, such as 5, to increase the importance of the current queue length in the queue state evaluation value.

When prioritizing maximum throughput, not considering traffic delay and assuming the system has sufficient packet buffer, the user can set the first weight to a lower value within the predetermined range (e.g., 0.1 to 10), such as less than 1. Alternatively, when prioritizing maximum throughput, and regardless of traffic delay, if the user aims to minimize packet loss, the first weight can be set to a lower value within the predetermined range (0.1-10), such as less than 1.

For latency-sensitive traffic, the user can set the first weight to a higher value within the predetermined range (0.1-10), such as 5. The user can configure a traffic classifier to identify latency-sensitive traffic (e.g., based on the protocol ID) and dynamically adjust the first weight and the second weight within the predetermined range (0.1-10).

In another embodiment, one of α and β is 0, and the other of α and β is not 0. That is, the queue state evaluation value is determined solely based on either the current queue length or the current queue delay, which serves as the input parameter for selecting the target egress port.

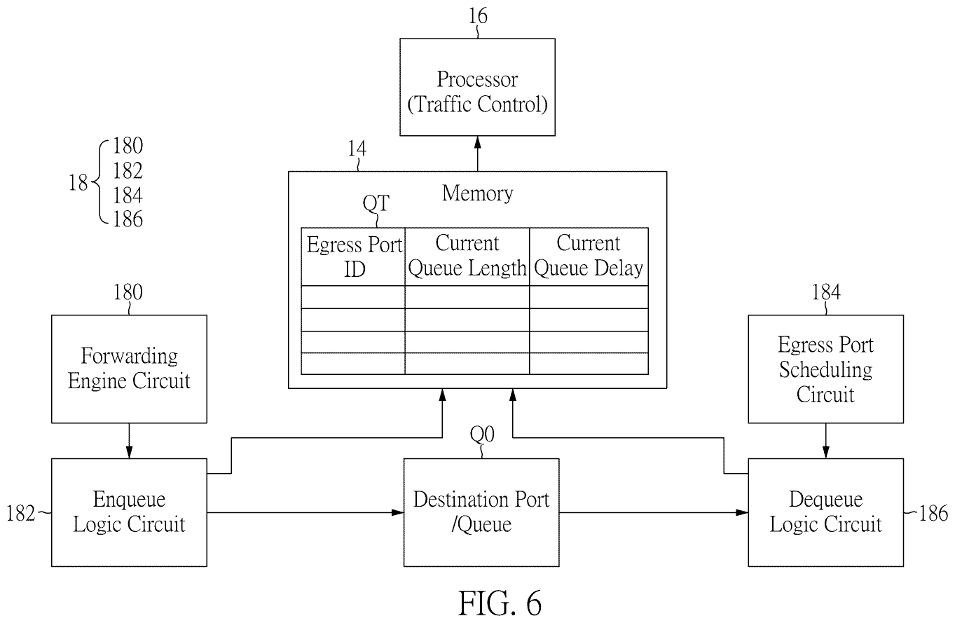

FIG. 6 is a schematic diagram illustrating a queue management circuit updating a queue state table according to one embodiment of the present disclosure. Referring to FIG. 6, the network gateway 1 further includes a queue management circuit 18, which is configured to update the queue state table QT stored in memory 14. For example, the queue management circuit 18 can be used to update the current queue length and the current queue delay of each ECMP member egress port. The queue management circuit 18 can include one or more logic circuits, such as a forwarding engine circuit 180, an enqueue logic circuit 182, an egress port scheduling circuit 184, and a dequeue logic circuit 186. The forwarding engine circuit 180 can be connected to the network interface circuit 12. When a to-be-forwarded packet of an ingress traffic is enqueued into a destination port/queue Q0, the forwarding engine circuit 180 can control the enqueue logic circuit 182 to increase the current queue length of the ECMP member egress port corresponding to the queue Q0 by 1, while also updating the current queue delay based on a timestamp of the to-be-forwarded packet.

On the other hand, when a to-be-forwarded packet of an ingress traffic has been transmitted through an ECMP member egress port, the egress port scheduling circuit 184 can control the dequeue logic circuit 186 to decrease the current queue length of the ECMP member egress port corresponding to the queue Q0 by 1, while also updating the current queue delay based on the timestamp of the to-be-forwarded packet.

Referring again to FIG. 2, in response to successfully finding the egress port corresponding to the ingress traffic in the traffic forwarding table in step S20, the routing method proceeds to step S24: forwarding the ingress traffic through the egress port.

In response to determining in step S22 that the target egress port is not the ECMP egress port, the routing method proceeds to step S25: loading the target egress port into the traffic forwarding table while forwarding the ingress traffic.

### Beneficial Effects of the Embodiments

In conclusion, in the network device and the routing method with the ECMP routing dynamic adjustment mechanism provided by the present disclosure, traffic can be dynamically adjusted and distributed based on the current traffic condition of each member egress port within the ECMP group, such as the queue length and the queue delay. Additionally, new traffic can be directed to the ECMP member egress port with the least congestion, which helps alleviate traffic congestion and minimizes traffic delay to the greatest extent.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A routing method with an equal-cost multi-path (ECMP) routing dynamic adjustment mechanism, the routing method comprising:
obtaining an ingress packet of an ingress traffic through a network interface circuit of a network device; and
configuring a processor of the network device to execute following processes:
extracting packet information from the ingress packet, and calculating and obtaining a forwarding decision parameter by using a traffic forwarding decision function;
continuously obtaining a plurality of current queue states of a plurality of ECMP member egress ports of an ECMP group; and
selecting one of the ECMP member egress ports from the ECMP group based on the forwarding decision parameter and the plurality of current queue states to forward the ingress traffic.

2. The routing method according to claim 1, wherein each of the plurality of current queue states includes at least one of a current queue length and a current queue delay.

3. The routing method according to claim 1, wherein each of the current queue states includes a current queue length and a current queue delay.

4. The routing method according to claim 1, further comprising: configuring the processor of the network device to execute following processes:
determining, upon receiving the ingress traffic, whether an egress port corresponding to the ingress traffic is found in a traffic forwarding table;
in response to failing to find the egress port corresponding to the ingress traffic in the traffic forwarding table, determining a target egress port corresponding to the forwarding decision parameter by using a routing table and a switching forwarding database;
determining whether the target egress port is an ECMP egress port; and
in response to determining that the target egress port is the ECMP egress port, selecting one of the ECMP member egress ports from the ECMP group based on the forwarding decision parameter and the plurality of current queue states to forward the ingress traffic.

5. The routing method according to claim 4, wherein the process of selecting one of the ECMP member egress ports from the ECMP group based on the forwarding decision parameter and the current queue states further includes:
selecting the ECMP member egress port with the shortest current queue length and the shortest current queue delay.

6. The routing method according to claim 4, wherein the process of selecting one of the ECMP member egress ports from the ECMP group based on the forwarding decision parameter and the current queue states further includes:
for each of the plurality of ECMP member egress ports, multiplying the current queue length by a first weight and adding the current queue delay multiplied by a second weight to obtain a queue state evaluation value; and
comparing all the queue state evaluation values and selecting the ECMP member egress port with the smallest queue state evaluation value.

7. The routing method according to claim 1, wherein the network device further includes:
a memory electrically connected to the processor, wherein the memory is configured to store a queue state table that defines correspondence between the plurality of ECMP member egress ports and the plurality of current queue states.

8. The routing method according to claim 7, wherein the network device further includes a queue management circuit configured to update a current queue length and a current queue delay for each of the ECMP member egress ports in the queue state table.

9. A network device with an equal-cost multi-path (ECMP) routing dynamic adjustment mechanism, the network device comprising:
a network interface circuit configured to obtain an ingress packet of an ingress traffic;
a memory; and
a processor electrically connected to the network interface circuit and the memory, wherein the processor is configured to execute:
extracting packet information from the ingress packet, and calculating and obtaining a forwarding decision parameter by using a traffic forwarding decision function;
continuously obtaining a plurality of current queue states of a plurality of ECMP member egress ports of an ECMP group; and
selecting one of the ECMP member egress ports from the ECMP group based on the forwarding decision parameter and the plurality of current queue states to forward the ingress traffic.

10. The network device according to claim 9, wherein each of the plurality of current queue states includes at least one of a current queue length and a current queue delay.

11. The network device according to claim 9, wherein each of the current queue states includes a current queue length and a current queue delay.

12. The network device according to claim 9, wherein the processor is further configured to execute:
in response to receiving the ingress traffic, finding an egress port corresponding to the ingress traffic in a traffic forwarding table;
in response to failing to find the egress port corresponding to the ingress traffic, determining a target egress port corresponding to the forwarding decision parameter by using a routing table and a switching forwarding database;
determining whether the target egress port is an ECMP egress port; and
in response to determining that the target egress port is the ECMP egress port, selecting one of the ECMP member egress ports from the ECMP group based on the forwarding decision parameter and the plurality of current queue states to forward the ingress traffic.

13. The network device according to claim 12, wherein the processor is configured to select the ECMP member egress port with the shortest current queue length and the shortest current queue delay.

14. The network device according to claim 12, wherein, when the processor is configured to select one of the ECMP member egress ports from the ECMP group based on the forwarding decision parameter and the current queue states, the processor is further configured to execute:
for each of the plurality of ECMP member egress ports, multiplying the current queue length by a first weight and adding the current queue delay multiplied by a second weight to obtain a queue state evaluation value; and
comparing all the queue state evaluation values and selecting the ECMP member egress port with the smallest queue state evaluation value.

15. The network device according to claim 9, wherein the memory is configured to store a queue state table that defines correspondence between the plurality of ECMP member egress ports and the plurality of current queue states.

16. The network device according to claim 15, further comprising a queue management circuit configured to update a current queue length and a current queue delay for each of the ECMP member egress ports in the queue state table.
